(19) United States
(12) Patent Application Publication
(10) Pub. No.: US 2003/0161035 A1
(43) Pub. Date: Aug. 28, 2003

(54) Three-dimensional optical amplifier structure

(75) Inventors: Patrick Georges, Palaiseau (FR); Francois Balembois, Boissy Le Sec (FR); Pierre Jean Devilder, Sainte Marie Du Mont (FR); Sebastien Forget, Arcueil (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS UNIPHASE CORPORATION, San Jose, CA

(21) Appl. No.: 10/342,437

(22) Filed: Jan. 13, 2003

(30) Foreign Application Priority Data
Jan. 15, 2002 (CA) 2,368,031
Feb. 1, 2002 (CA) 2,370,037

(51) Int. Cl. H01S 3/00

(52) U.S. Cl. 359/347

(57) ABSTRACT

A multi-pass three-dimensional amplifier structure in which a beam to be amplified traverses an amplifier medium multiple times through distinct multiple paths. The distribution of the multiple paths being such that the volume occupied by said multiple paths inside the amplifier medium substantially overlaps with the volume of the amplifier medium being optically pumped by an optical pump beam. Also, the distribution of said optical paths being such that no more than two of the multiple paths lie in a same plane.

### RELATED APPLICATIONS

This application claims priority from Canadian patent application number 2,368,031 filed Jan. 15, 2002 and from Canadian patent application number 2,370,037 filed Feb. 1, 2002.

### FIELD OF THE INVENTION

The present invention relates to an optical amplifier, and in particular to a three-dimensional optically pumped amplifier structure for lasers.

### BACKGROUND OF THE INVENTION

Production of short pulses with high energy per pulse is usually achieved by a combination of one oscillator and one amplifier. The oscillator is traditionally a mode-locked laser producing very short pulses, typically less than 100 ps, at high frequency, typically a few tens of MHz, and with low energy per pulse, typically a few nJ. To increase the pulse energy to several μJ, one uses an amplifier working at a lower repetition rate from a few kHz to a few hundreds of kHz, depending on the pumping configuration. These systems are complex and complicated to use because they involve active modulation (acousto-optic or electro-optic), high-speed electronics, short-pulse production for the oscillator, and injection and synchronization of the pulses inside the amplifier.

Passively Q-switched lasers using Nd-doped crystals can produce high peak power pulses of several kW at a wavelength of 1064 nm. Depending on the experimental setup, the pulse width can vary from a few tens of ns (A. Agnesi, S. Dell'Acqua, E. Piccinini, G. Reali and G. Piccinno, “Efficient wavelength conversion with high power passively Q-switched diode-pumped neodymium laser”, IEEE, J. Q. E., Vol. 34, 1480-1484, 1998) to a few hundreds of ps (J. J. Zayhowski, “Diode-pumped passively Q-switched picosecond microchip lasers”, Opt. Lett., Vol. 19, 1427-1429, 1994). For example, pulses of 19 ns and 108 μJ can be obtained at 25 kHz and 1064 nm from a diode-pumped Nd:YAG laser with a Cr⁴⁺:YAG saturable absorber crystal. The high peak power of these lasers allows efficient wavelength conversion into the ultra-violet (UV) range with optically nonlinear materials (A. Agnesi, S. Dell'Acqua, E. Piccinini, G. Reali and G. Piccinno, “Efficient wavelength conversion with high power passively Q-switched diode-pumped neodymium laser”, IEEE, J. Q. E., Vol. 34, 1480-1484, 1998; J. J. Zayhowski, “Diode-pumped passively Q-switched picosecond microchip lasers”, Opt. Lett., Vol. 19, 1427-1429, 1994; J. J. Zaykowski, “UV generation with passively Q-switched microchip laser”, Opt. Lett., Vol. 21, 588-590, 1996).

To reduce the pulse width, while using the same material combination, one must combine the active medium and the saturable absorber in a short distance to reduce the cavity length to about 1 mm. A microchip laser combines the two materials in a monolithic crystal (J. J. Zaykowski, “Non linear frequency conversion with passively Q-switched microchip lasers”, CLEO 96, paper CWA6, 23 6-237, 1996) to reduce the energy to approximately 8 μJ at 1064 nm. The two materials, i.e. the laser material and the saturable absorber, can be connected by thermal bonding, or the saturable absorber can be grown by liquid phase epitaxy (LPE) directly on the laser material (B. Ferrand, B. Chambaz, M. Couchaud, “Liquid Phase Epitaxy: a versatile technique for the development of miniature optical components in single crystal dielectric media”, Optical Materials 11, 101, 1998). At the same time, in order to obtain sub-nanosecond pulses, the saturable absorber must be highly doped to lower the repetition rate, e.g. 6-8 kHz with Nd:YAG. The wavelength conversion efficiency from infrared (IR) to UV is in the order of 4%. A solution to simultaneously obtain short pulses and a high repetition rate is to combine a Nd:YVO₄ crystal, whose short fluorescence lifetime is well suited for a higher repetition rate, with a semiconductor-based saturable absorber in an anti-resonant Fabry-Perot structure (B. Braun, F. X. Kdarner, G. Zhang, M. Moser, U. Keller, “56 PS passively Q-switched diode-pumped microchip laser”, Opt. Lett., 22, 381-383, 1997). Unfortunately this structure is nevertheless complex and very difficult to produce.

It is therefore difficult to simultaneously produce sub-nanosecond short pulses, at frequencies of a few tens of kHz, with several micro-Joule per pulse in a simple and compact system. Another solution consists of combining a compact oscillator, producing short pulses at high frequency, with an amplifier to increase the pulse energy. Amplifiers have been used in the past with pulsed microlasers. After amplification, pulses with 87 nJ (small-signal gain of 3.5) at 100 kHz have been produced using a 10-W diode bar as a pump (C. Larat, M. Schwarz, J. P. Pocholle, G. Feugnet, M. Papuchon, “High repetition rate solid-state laser for space communication”, SPIE, Vol. 2381, 256-263). A small-signal gain of 16 has been obtained with an 88-pass complex structure using two 20-W diode bars as a pump (J. J. Degnan, “Optimal design of passively Q-switched microlaser transmitters for satellite laser ranging”, Tenth International Workshop on Laser Ranging Instrumentation, Shanghai, China, Nov. 11-15, 1996). In these two examples, the amplification efficiency that can be defined as the ratio between the small-signal gain and the pump power is small because the transverse pumping has a low efficiency due to the poor overlap of the gain areas with the injected beam. Furthermore, these setups use Nd:YAG crystals not suited for high-frequency pulses (the fluorescence lifetime is 230 μs).

A combination of Nd ions in two different hosts, in an oscillator-amplifier system, has been performed in the past in continuous wave (CW) (H. Plaesmann, S. A. Re, J. J. Alonis, D. L. Vecht, W. M. Grossmann, “Multipass diode-pumped solid-state optical amplifier”, Opt. Lett., 18, 1420-1422, 1993) or pulsed mode (C. Larat, M. Schwarz, J. P. Pocholle; G. Feugnet, M. Papuchon, “High repetition rate solid-state laser for space communication”, SPIE, Vol. 2381, 256-263). In these cases, the spectral distance between the emission lines of the two different materials, i.e. Nd:YAG and Nd:YVO₄, limits the small-signal gain to a value lower than that obtained when only Nd:YVO₄ is used in both the oscillator and the amplifier; the aforementioned spectral distance is comprised between 5.5 cm⁻¹ and 7.0 cm⁻¹ (J. F. Bernard, E. Mc Cullough, A. J. Alcock, “High gain, diode-pumped Nd:YVO₄ slab amplifier”, Opt. Commun., Vol. 109, 109-114, 1994).

A number of amplification schemes using Nd ions in crystals have been studied, but often end up with complex multipass setups, with low efficiency due to transverse pumping.

End-pumped single-pass or double-pass amplification schemes based on guiding structures to increase the interaction length between the pump beam and the injected beam have been studied in the past: in planar guides (D. P. Shepherd, C. T. A. Brown, T. J. Warburton, D. C. Hanna and A. C. Tropper, “A diode-pumped, high gain, planar waveguide Nd:Y₃ Al₅O₁₂ amplifier”, Appl. Phys. Left., 71, 876-878, 1997) or in double-cladding fibers (E. Rockat, K. Haroud, R. Dandliker, “High power Nd-doped fiber amplifier for coherent intersatellite links”, IEEE, JQE, 35, 1419-1423, 1999; I. Zawischa, K. Plaman, C. Fallnich, H. Welling, H. Zellner, A. Tunnermann, “All solid-state neodymium band single frequency master oscillator fiber power amplifier system emitting 5.5 W of radiation at 1064 nm”, Opt. Lett., 24, p. 469-471, 1999). These schemes are, however, not suited for high-peak-power pulses because unwanted nonlinear effects, such as the Raman effect, start to appear around 1 kW of peak power.

A high small-signal gain of 240 was achieved in an end-pumped double-pass bulk Nd:YLF amplifier, but it was used with a CW laser with an expensive diode-beam shaping optical setup (G. J. Friel, W. A. Clarkson, D. C. Hanna, “High gain Nd:YLF amplifier end-pumped by a beam shaped bread-stripe diode laser”, CLEO 96, paper CTUL 28, p. 144, 1996).

U.S. Pat. No. 6,373,864, Georges et al., issued Apr. 16, 2002, incorporated herein by reference, discloses an entirely passive laser system both for the generation and amplification of short pulses. In the Georges et al. invention, the oscillator directly produces pJ pulses at the required repetition rate, and the pulses are amplified after only a few passes in a non-synchronized amplifier. The uniqueness of that approach was to combine an optically pumped, passively Q-switched, high frequency, Nd:YAG microchip laser producing short pulses with an optically end-pumped Nd:YVO₄ amplifier producing high small-signal gain while pumped at low power. The use of the two materials, Nd:YAG and Nd: YVO₄, allowed the best use of their respective properties: Nd:YAG/Cr⁴+:YAG microchip lasers are simpler and easier to manufacture than Nd:YVO₄ microchips because they use the same crystal (YAG) for the laser medium and the saturable absorber, and can be produced in a collective fashion. In addition they produce shorter pulses except in the case of the semiconductor saturable absorber described in B. Braun, F. X. Kartner, G. Zhang, M. Moser, U. Keller, “56 ps passively Q-switched diode-pumped microchip laser”, Opt. Lett., 22, 381-383, 1997. Nd:YVO₄ is on the other hand well suited for amplification due to its high stimulated emission cross section. It is also better suited than Nd:YAG for higher repetition rates due to a shorter fluorescence lifetime (100 μs instead of 230 μs).

In the invention disclosed be Georges et al., the light beam to be amplified initially gets passed through the amplifier medium along a first path and subsequently gets reflected back through the amplifier medium along a second path, thereby traversing the amplifier medium twice. The planar geometry used by Georges et al. is not optimal since the pump beam propagates in three dimensions whereas the light beam to be amplified travels in a single plane. This results in poor overlap between the volume occupied in the amplifier medium by the pump beam and the volume occupied in the amplifier medium by the light beam to be amplified. Georges et al. alludes to multi-pass scenarios wherein the light beam to be amplified traverses the amplifier medium at least twice. Such multi-pass amplification schemes are known. For instance, McIntyre discloses co-linear and two-dimensional multi-pass amplification schemes in U.S. Pat. No. 5,268,787, issued Dec. 7, 1993, incorporated herein by reference. Plaessmann et al., in U.S. Pat. No. 5,546,222, issued Aug. 13, 1996, incorporated herein by reference, discloses a multi-pass laser amplifier that uses optical focussing between subsequent passes through a single gain medium. The multi-pass laser amplification schemes disclosed by Plaessman et al. are all two-dimensional schemes, i.e. the multi-paths of the light beam traversing the amplifier medium all lie in a same plane. The number of optical components used in the embodiments taught by Plaessman et al. is relatively small and consequently, the alignment of said components is crucial in view of the multi-pass amplification scheme.

Three-dimensional amplification schemes are also known. C. LeBlanc et al., “Compact and efficient multipass Ti:sapphire system for femtosecond chirped-pulse amplification at the terawatt level”, Optics Letters, Vol. 18, No. 2, Pp. 140-142, Jan. 15, 1993, discloses a Ti:sapphire crystal amplifier medium pumped at two ends by Nd:YAG light and traversed 8 times by the light beam to be amplified. The light beam to be amplified traverses the amplifier medium four times in a first plane and four other times in a distinct second plane parallel to the first plane. Another three-dimensional amplification scheme is that of Scott et al., “Efficient high-gain laser amplification from a low-gain amplifier by use of self-imaging multipass geometry”, Applied Optics, Vol. 40, No. 15, Pp. 2461-2467, 20 May 2001. Scott et al. illustrates how the light beam to be amplified traverse the amplifier medium four times in a first plane and four additional times in a distinct other plane parallel to the first plane. A phase-conjugate mirror is then used to double the number of passes.

The three-dimensional amplification schemes discussed above are quite complex and not well suited for miniaturization.

### SUMMARY OF THE INVENTION

An object of the invention is to provide a method for amplifying a light beam comprising the step of passing a light beam through an amplifying medium along multiple paths, wherein no more than two of the multiple paths lie in a same plane.

A further object of the invention is to provide an optical amplifier stage for amplifying a light beam comprising:

a) a first lens having a collimating end, a focussing end, an optical axis, and a focal point lying on the optical axis, the first lens for receiving the light beam at the collimating end for directing the light beam towards the focal point along a path s₁;

b) an amplifying medium disposed along the optical axis for amplifying the light beam propagating along s₁;

c) a reflector disposed for reflecting the light beam back through the amplifier medium towards the focussing end of the first lens along a path s₂ to amplify the light beam, wherein s₁ and s₂ lie in a same plane P₁;

d) N redirecting means {R₁, R₂, R₃, . . . ,R_{N}}, N being a natural number, disposed adjacent the collimating end of the lens;

wherein redirecting means Rₓ, x being a natural number between 1 and N, is for receiving the light beam having propagated along the path s₂ₓ, and for redirecting the light beam through the first lens back through the amplifier medium along a path s₂ₓ₊₁ to amplify the light beam; wherein, s₂ₓ₊₁ and s₂₍ₓ₊₁₎ lie in a same plane Pₓ₊₁; and,

wherein all the planes are distinct.

A further object of the invention is to provide an optical amplifier stage for amplifying a light beam comprising:

a) a lens having a collimating end, a focusing end, an optical axis, and a focal point lying on the optical axis, the lens for receiving the light beam at the collimating end, and for directing the light beam towards the focal point;

b) an amplifying medium disposed along the optical axis for amplifying the light beam traveling therethrough;

c) a reflector for reflecting the light beam back through the amplifying medium towards the focusing end of the lens; and

d) at least one reflecting means disposed adjacent the collimating end of the lens, each reflecting means for receiving the light beam from the reflector via the amplifying medium and the lens, and for reflecting the light back through the lens and the amplifying medium to the reflector;

wherein each time the light beam passes back and forth between the reflector and one of the reflecting means the light beam travels in a different plane through the amplifying medium.

### BRIEF DESCRIPTION OF THE DRAWINGS

FIG. 1 is a schematic illustration of a prior art laser system;

FIGS. 2a and 2b is a schematic illustration of a prior art optically pumped amplifier structure;

FIG. 3 is a schematic illustration of an embodiment of the present invention; and,

FIG. 4 is a cross-sectional view of an amplifier medium of the embodiment of FIG. 3;

FIG. 5 is a schematic illustration of an alternative embodiment of the present invention;

FIG. 6 is a cross-sectional view of an amplifier medium of the embodiment of FIG. 5;

FIGS. 7a and 7b are schematic illustrations of a redirecting means in the form of a recirculating fiber; and

FIGS. 8a and 8b are schematic illustrations showing the equivalent performance of a roof prism compared to two mirrors.

### DETAILED DESCRIPTION OF THE INVENTION

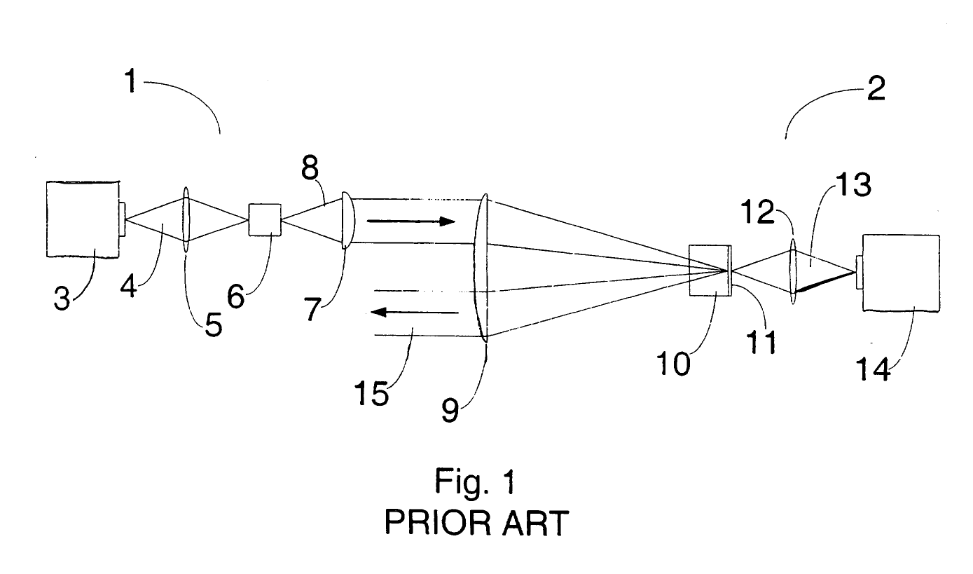

FIG. 1 depicts a conventional entirely passive laser system for both the generation and amplification of short pulses, the full description of which is found in U.S. Pat. No. 6,373,864, issued to Georges et al. on Apr. 16, 2002. The Georges et al. laser system comprises a first sub-system; i.e. a microchip laser stage 1, and a second sub-system; i.e. an amplifier stage 2. In the microchip laser stage 1, a first pump laser 3 emits a first pumping radiation 4, which is directed by a first lens 5 towards a microchip laser 6. The microchip laser 6 comprises reflective elements, a first gain medium and a saturable absorber, all of which are not depicted. A microchip laser beam 8 is directed by lenses 7 and 9 towards an amplifying medium 10 which is optically pumped by a second pump laser 14, whose pumping radiation 13 is directed towards the amplifying medium 10 by a lens 12. A dichroic filter 11, transparent to pumping radiation 13 and reflective to the microchip laser beam 8, is disposed at an end of the amplifying medium 10. The pumping radiation 13, generated by pump laser 14, is transmitted through the dichroic filter 11 and excites the amplifier medium 10, while the microchip laser beam 8, traversing the amplifying medium 10 a first time for a first amplification, is reflected by the dichroic filter 11 back through the amplifying medium 10 a second time for a second amplification. A twice-amplified microchip laser beam 15 is directed by lens 9 to an optical circuit (not shown).

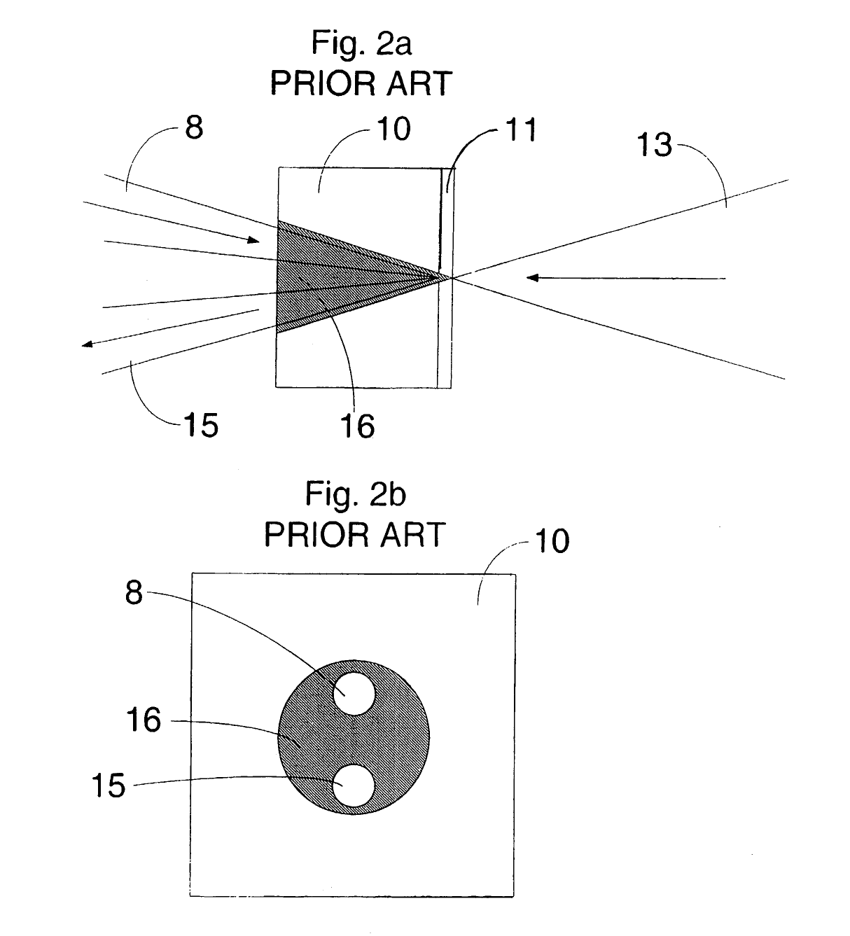

FIGS. 2a and 2b illustrate the amplifying medium 10 being pumped by the pumping radiation 13. Shaded area 16 depicts a cross-sectional view of the volume being optically pumped by the pumping radiation 13. It is apparent from FIGS. 2a and 2b that the optically pumped volume 16 of the amplifying medium 10 is not being substantially overlapped by the microchip laser beam 8 and the twice-amplified microchip laser beam 15.

The present invention addresses the poor overlap situation by disclosing a three-dimensional amplification scheme that sees the beam to be amplified travel along multiple paths inside the amplifier medium with the combined volume occupied by the multiple paths inside the amplifier medium substantially overlapping with the volume occupied by the optical pump beam. This provides a laser system with high gain and good efficiency.

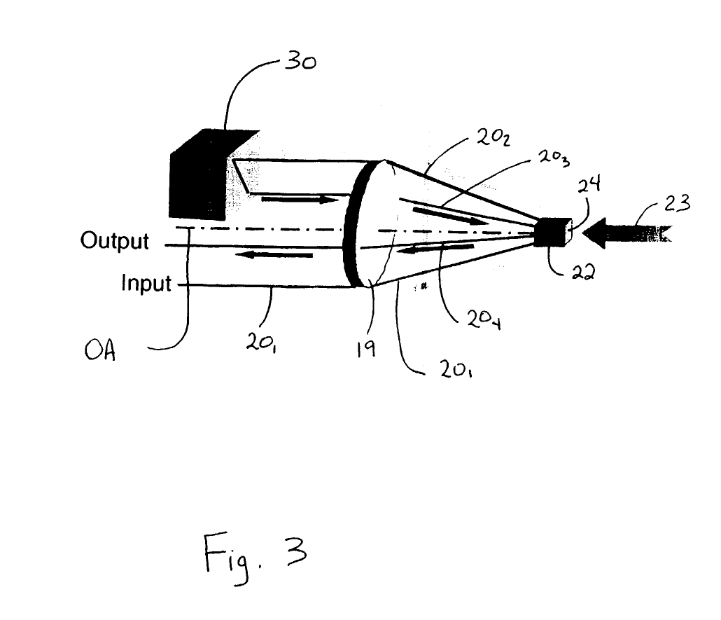

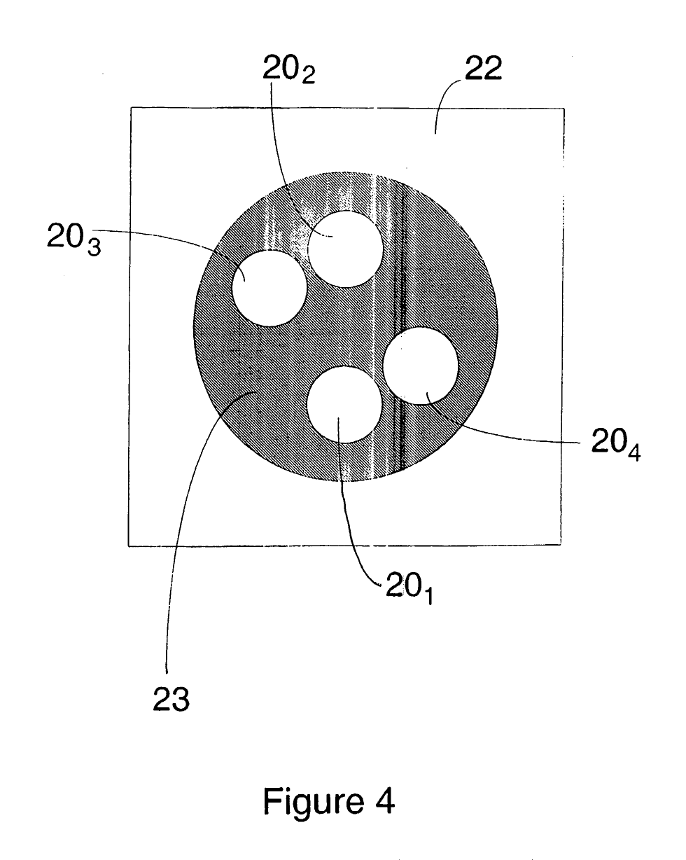

FIG. 3 depicts a preferred embodiment of the present invention. A beam of light to be amplified 20₁ propagates parallel to the optical axis (OA) of a lens 19 and is directed by the lens 19 towards an amplifier medium 22, which is being optically pumped at a wavelength λₚ by a pump beam 23 through a dichroic filter 24 transparent to λₚ. The beam 20₁, having a wavelength λ₁, traverses the amplifier medium 22 for a first time along a first path for a first amplification and is reflected by the dichroic filter 24. The reflected beam 20₂ traverses the amplifier medium a second time for a second amplification along a second path and is directed by the lens 19 towards a reflector in the form of a corner cube 30. The corner cube 30 displaces the beam 20₂ into a displaced beam 20₃ and reflects the beam 20₃ back towards the lens 19, which directs the beam 20₃ along a third path towards the amplifier medium 22 for a third amplification. The dichroic filter 24 reflects the beam a second time and the reflected beam 20₄ traverses the amplifier medium for a fourth amplification along a fourth path. Subsequently, the beam 20₄ is directed towards an output port, preferably via the lens 19. It is important to note that the plane defined by the first and second paths and the plane defined by the third and fourth paths are distinct due to the beam-displacing action of the corner cube 30. Having distinct planes imply that the combined volume occupied by the beam paths inside the amplifier medium 22 is greater than it would be were it not for the presence of the corner cube 30. FIG. 4 shows a cross-sectional view of the amplifier medium 22 and a pump beam area 23 populated by areas occupied by the light beam to be amplified as it propagates along the first, second, third and fourth paths here labeled by the corresponding beam numerals 20₁, 20₂, 20₃ and 20₄. Although the embodiment just described has the input beam 20₁ and the output beam 20₄ traversing the lens 19, it is not necessary that they do so for the invention to work.

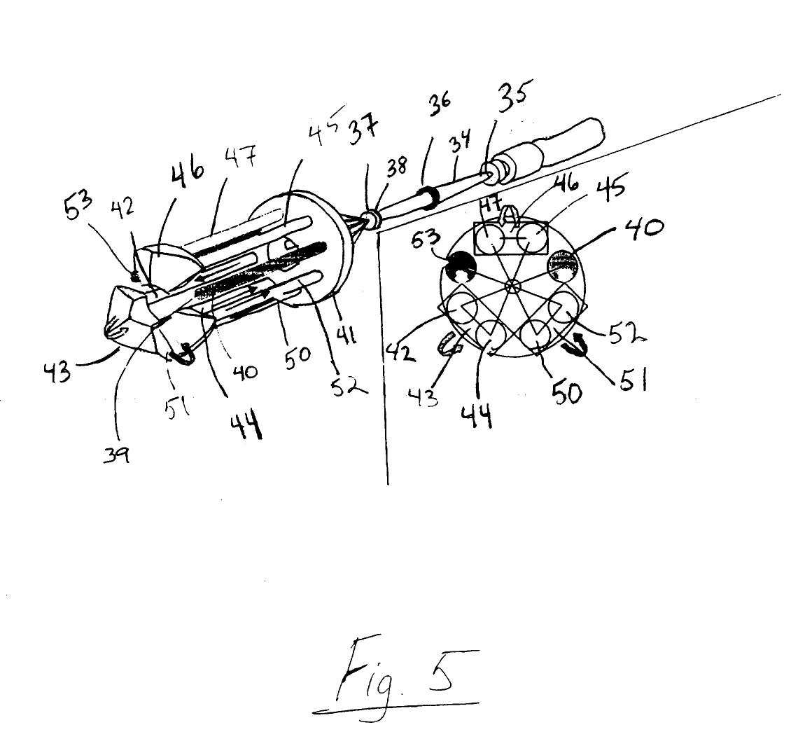

FIG. 5 depicts an alternative embodiment of the present invention. In FIG. 5, the output pump beam 34 of a fiber coupled diode array 35 is imaged by a lens 36 on an amplifier medium 37 through a dichroic filter 38. A light beam to be amplified 39 propagates along a first path 40 towards a lens 41, which directs the beam 39 towards the amplifier medium 37 and the dichroic filter 38. The dichroic filter 38 reflects the light beam 39 back through the amplifier medium 37 and towards the lens 41, which directs beam 39 along a second path 42 to a first roof prism 43. The roof prism 43 reflects and displaces the beam 39 to propagate along a third path 44 towards the lens 41, which directs the beam 39 towards the amplifier medium 37 and the dichroic filter 38. Again, the dichroic filter 38 reflects the beam 39 for propagation through the amplifier medium 37 and towards the lens 41, which directs the beam 39 along a fourth path 45 to a second roof prism 46. The roof prism 46 reflects and displaces the beam 39 to propagate along a fifth path 47 towards the lens 41, which directs beam 39 through the amplifier medium 37 to the dichroic filter 38. Once more, the dichroic filter 38 reflects the beam 39 through the amplifier medium 37 and towards the lens 41, which directs the beam 39 along a sixth path 50 to a third roof prism 51. The roof prism 51 reflects and displaces the beam 39 to propagate along a seventh path 52 towards the lens 41, which directs beam 39 through the amplifier medium 37 to dichroic filter 38. And again, the dichroic filter 38 reflects the beam 39 for propagation through the amplifier medium 37 and towards the lens 41, which directs the beam 39 along an eight path 53 towards an output port (not shown). The beam 39 is amplified each time it traverses the amplifier medium 37 and consequently, according to the description just given, is amplified eight times.

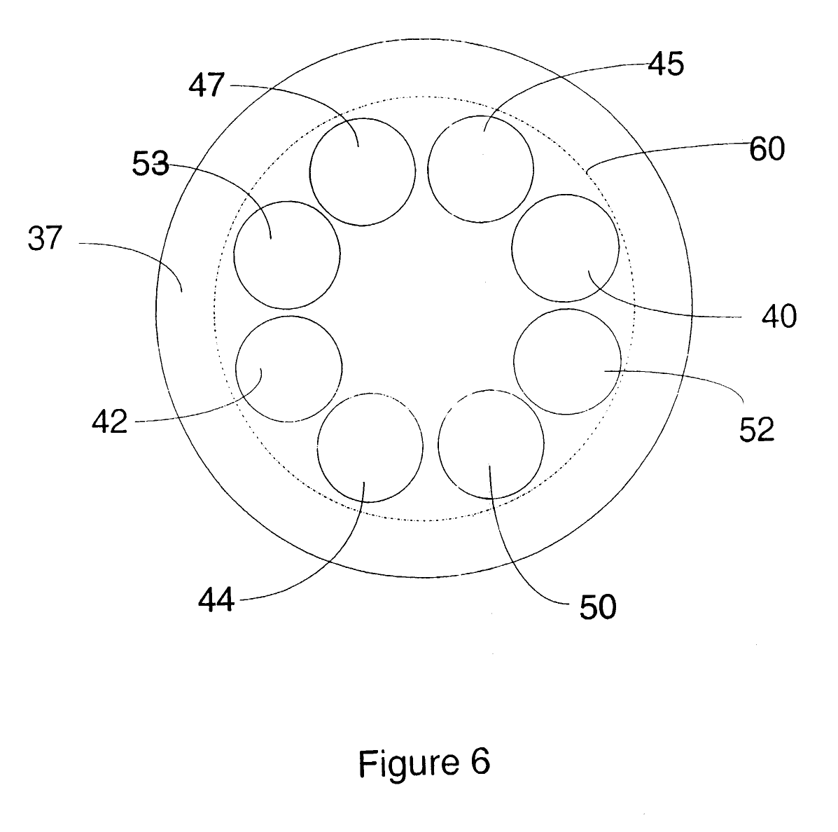

FIG. 6 shows a cross-sectional view of the amplifier medium 37 with a concentric dashed circle 60 representing the area of the cross-section being optically pumped by the pump beam 34. Also shown in FIG. 6 are the areas of beam 39 traveling along the various paths 40, 45, 47, 53, 42, 44, 50, and 52 as they intercept the cross-section of the pump beam. One can observe in FIG. 6 that the area covered by beam paths 40, 45, 47, 53, 42, 44, 50, and 52 substantially overlap the area 60 covered by the pump beam 34.

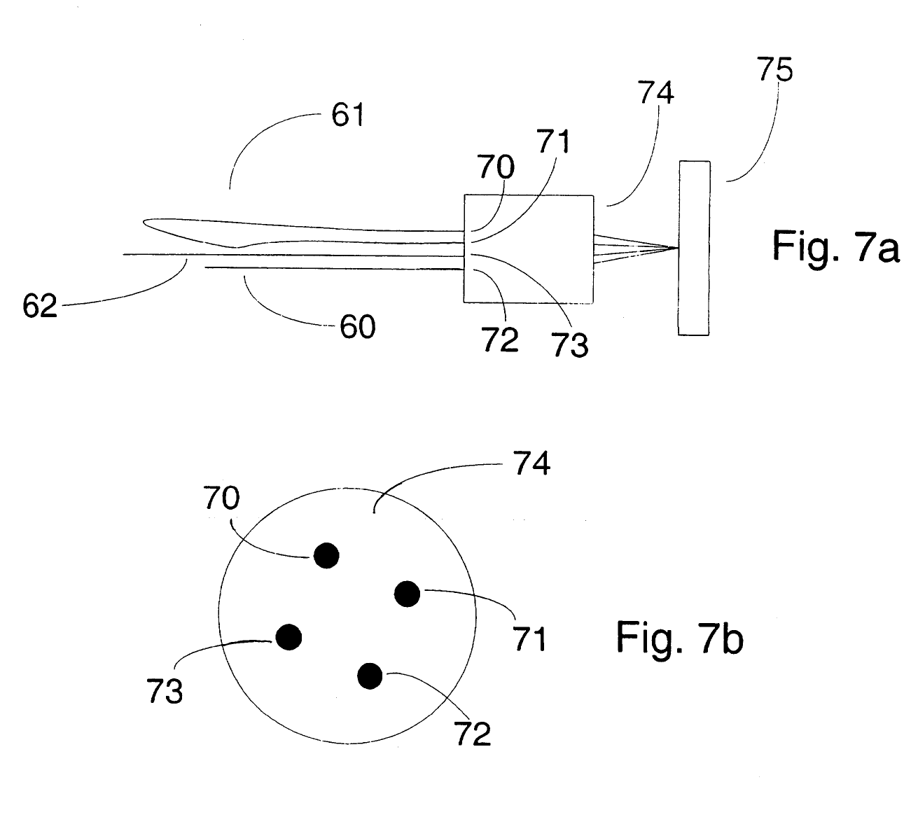

It should be clear to those skilled in the art that the corner cube of the former embodiment and the roof prisms of the latter embodiment can be replaced by a number of equivalent redirecting means. Such alternative redirecting means include recirculating fiber and mirrors. For example, FIG. 7a illustrates how a recirculating fiber 62 can be used to replace the roof prisms or the corner cube of the previously described embodiments. In FIG. 7a, a beam of light 60 propagates towards a lens 74, intersects the lens 74 at a port 72 and is directed along a first path by the lens 74 towards a reflector 75. The beam 60 is then reflected towards the lens 74 along a second path by the reflector 75 and is directed by the lens 74 towards a first end of a recirculating fiber 61, said first end located at port 70. The beam 60 propagates through the recirculating fiber 61 and exits the recirculating fiber 61 at port 71. The beam 60 is then directed along a third path by the lens 74 towards the reflector 75. The beam 60 is then reflected towards the lens 74 along a fourth path by the reflector 75 and is directed by the lens 74 towards a port 73. The beam of light 60 then exits the port 73 as an output beam 62. In FIG. 7a, the first and second paths form a first plane, the third and fourth paths form a second plane and the first and second planes are distinct. Since FIG. 7a was meant to illustrate how a recirculating fiber can serve as a redirecting means equivalent to corner cubes and roof prisms, the amplifier medium present in the aforementioned embodiments was left out. FIG. 7b is frontal view of the side of the lens 74 having the ports 70, 71, 72 and 73.

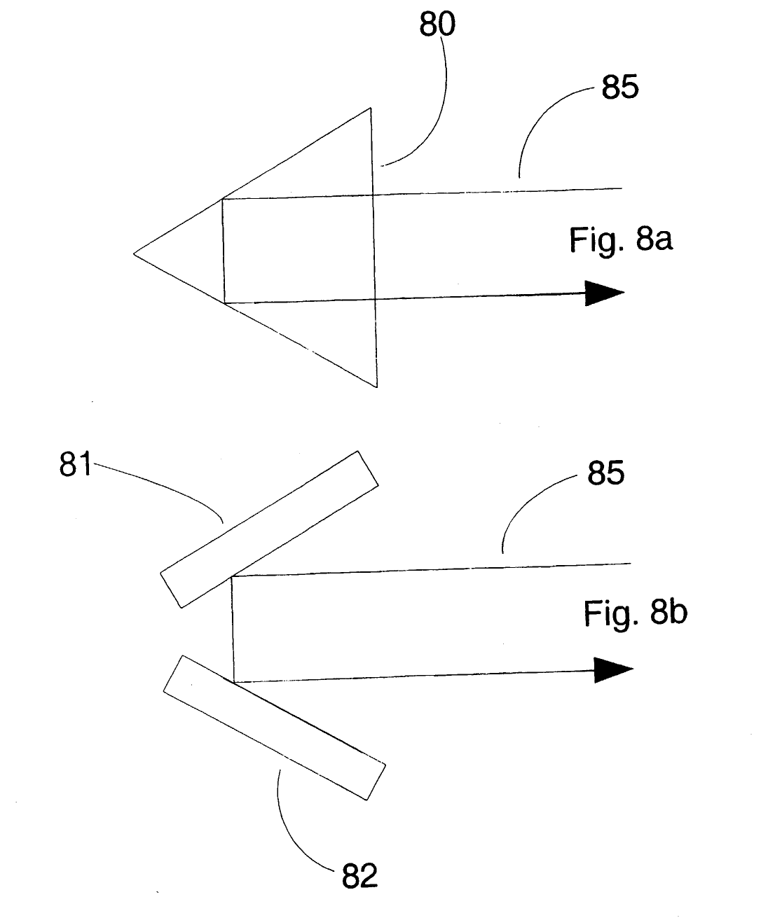

As another example of redirecting means, FIGS. 8a and 8b show how mirrors can perform the equivalent task of a roof prism. In FIG. 8a one can see an optical beam 85 entering a roof prism 80 and being redirected by the roof prism 80. FIG. 8b shows how the two mirrors 81 and 82 perform the same function as the roof prism 80 on the beam 85. Although not illustrated, one will understand that a combination of mirrors can function as a corner cube.

Many types of amplifier medium can be envisaged in the present invention. Amongst others, Nd:YVO₄, Nd:YAG, Yb:YAG, Er:glass and Yb:glass can all be utilized as the amplifier medium.

It is possible to devise embodiments other than the ones described here without departing from the spirit and scope the present invention.

What is claimed is:

1. An optical amplifier stage for amplifying a light beam comprising:
a) a first lens having a collimating end, a focussing end, an optical axis, and a focal point lying on the optical axis, the first lens for receiving the light beam at the collimating end for directing the light beam towards the focal point along a path s₁;
b) an amplifying medium disposed along the optical axis for amplifying the light beam propagating along s₁;
c) a reflector disposed for reflecting the light beam back through the amplifier medium towards the focussing end of the first lens along a path s₂ to amplify the light beam, wherein s₁, and s₂ lie in a same plane P₁;
d) N redirecting means {R₁, R₂, R₃, . . . ,R_{N}}, N being a natural number, disposed adjacent the collimating end of the lens;
wherein redirecting means Rₓ, x being a natural number between 1 and N, is for receiving the light beam having propagated along the path s₂ₓ, and for redirecting the light beam through the first lens back through the amplifier medium along a path s₂ₓ₊₁ to amplify the light beam;
wherein, s₂ₓ₊₁ and s₂₍ₓ₊₁₎ lie in a same plane Pₓ₊₁; and,
wherein all the planes are distinct.

2. An optical amplifier stage as described in claim 1 further comprising an optical pump for pumping the amplifier medium with an optical pump beam; wherein
the light beam is at a wavelength λ₁;
the pump beam is at a wavelength λ₂; and
the reflector is substantially reflective at λ₁ and substantially transmissive at λ₂;
wherein the optical pump beam is transmitted through the reflector to optically pump the amplifying medium.

3. An optical amplifier stage as described in claim 2, further comprising a second lens for focusing the optical pump beam to a focal point located proximate the reflector, said optical pump beam diverging passed the focal point, wherein the optical pump beam transmitted through the reflector is for illuminating a pumping volume of the amplifying medium, said pumping volume being a function of focusing properties of the second lens;
wherein the paths are distributed in said pumping volume to substantially overlap with the pumping volume.

4. An optical amplifier stage as described in claim 3, wherein the focal point of the second lens is located between the second lens and the amplifying medium, whereby the pumping volume of the amplifier medium is in the form of a conical frustum.

5. An optical amplifier stage as described in claim 1, wherein each the redirecting means is selected from a group consisting of mirrors, roof prisms, corner cubes and recirculating fibers.

6. An optical amplifier stage as described in claim 1, wherein said amplifying medium is selected from a group consisting of Nd:YVO₄, Nd:YAG, Yb:YAG, Er:glass and Yb:glass.

7. A laser system for emitting a pulsed light beam comprising:
a microchip laser for emitting pulsed laser radiation, said microchip laser having: two reflective elements defining an optical resonator for laser radiation, a laser gain medium placed inside said resonator and a saturable absorber medium placed inside said resonator for passively Q-switching said laser radiation, said reflective elements, said gain medium and said saturable absorber medium being rigidly and irreversibly bonded such as to form a monolithic body, and
an optical pump source for emitting pumping radiation which impinges on said monolithic body and excites said gain medium to emit a pulsed laser radiation light beam; and
an optical amplifier stage as defined in claim 1 for amplifying the pulsed laser radiation light beam;
the microchip laser and optical amplifier being mutually arranged such that the laser radiation light beam emitted by the microchip laser is amplified by the optical amplifier.

8. An optical amplifier stage for amplifying a light beam comprising:
a) a lens having a collimating end, a focusing end, an optical axis, and a focal point lying on the optical axis, the lens for receiving the light beam at the collimating end, and for directing the light beam towards the focal point;
b) an amplifying medium disposed along the optical axis for amplifying the light beam traveling therethrough;
c) a reflector for reflecting the light beam back through the amplifying medium towards the focusing end of the lens; and
d) at least one reflecting means disposed adjacent the collimating end of the lens, each reflecting means for receiving the light beam from the reflector via the amplifying medium and the lens, and for reflecting the light back through the lens and the amplifying medium to the reflector;
wherein each time the light beam passes back and forth between the reflector and one of the reflecting means the light beam travels in a different plane through the amplifying medium.

9. The optical amplifier stage as described in claim 8, further comprising an optical pump beam for pumping the amplifier medium, wherein the light beam is at a first wavelength and the pump beam is at a second wavelength; wherein the reflector is substantially reflective at the first wavelength and substantially transmissive at the second wavelength, whereby the pump beam is transmitted through the reflector to optically pump the amplifying medium.

10. An optical amplifier stage as described in claim 9, further comprising a second lens for focusing the optical pump beam to a focal point located proximate the reflector, said optical pump beam diverging passed the focal point, wherein the optical pump beam transmitted through the reflector is for illuminating a pumping volume of the amplifying medium, said volume being a function of the focusing properties of the lens;
wherein the paths are distributed in said pumping volume to substantially overlap with the pumping volume.

11. An optical amplifier stage as described in claim 9, wherein the focal point of the second lens is located between the second lens and the amplifying medium, whereby the pumping volume of the amplifier medium is in the form of a conical frustum.

12. An optical amplifier stage as described in claim 8, wherein the reflecting means is chosen from a group consisting of mirrors, roof prisms and corner cubes.

13. An optical amplifier stage as described in claim 8, for amplifying a pulsed light beam.

14. An optical amplifier stage as described in claim 8, wherein the amplifying medium is selected from a group consisting of Nd:YVO₄, Nd:YAG, Yb:YAG, Er:glass and Yb:glass.

15. A laser system for emitting a pulsed light beam comprising:
a microchip laser for emitting pulsed laser radiation, said microchip laser having: two reflective elements defining an optical resonator for laser radiation, a laser gain medium placed inside said resonator and a saturable absorber medium placed inside said resonator for passively Q-switching said laser radiation, said reflective elements, said gain medium and said saturable absorber medium being rigidly and irreversibly bonded such as to form a monolithic body, and
an optical pump source for emitting pumping radiation which impinges on said monolithic body and excites said gain medium to emit a pulsed laser radiation light beam; and
an optical amplifier stage as defined in claim 8 for amplifying the pulsed laser radiation light beam;
the microchip laser and optical amplifier being mutually arranged such that the laser radiation light beam emitted by the microchip laser is amplified by the optical amplifier.

16. A method for amplifying a light beam comprising the step of passing a light beam through an amplifying medium along multiple paths, wherein no more than two of the multiple paths lie in a same plane.

17. A method for amplifying a light beam as described in claim 16 further comprising the step of pumping a pump volume of the amplifying medium with a pump beam, wherein the pump volume and a volume comprising the multiple paths substantially overlap.
